(19) United States
(12) Patent Application Publication
(10) Pub. No.: US 2019/0255878 A1
(43) Pub. Date: Aug. 22, 2019

(54) MATRIX FOR IMPRINTING A RAISED PATTERN ON A COATING

(71) Applicant: SAINT-GOBAIN WEBER, SERVON (FR)

(72) Inventors: Anne DEVORET, PARIS (FR); Camille CLAUDE, PARIS (FR); Stéphanie BALESTE, PONCIN (FR); Antoine GIRET, PARIS (FR)

(21) Appl. No.: 16/331,011

(22) PCT Filed: Sep. 7, 2017
(86) PCT No.: PCT/FR2017/052370

§ 371 Date: Mar. 6, 2019

(30) Foreign Application Priority Data
Sep. 8, 2016 (FR) 1658361

(51) Int. Cl. B44C 1/24; E04F 21/04

(52) U.S. Cl. CPC B44C 1/24; B44B 11/04; E04F 21/04

(57) ABSTRACT

A mat for imprinting a texture on a coating, notably a coating applied to a wall, a floor or a ceiling, includes a surface with a random texture to be imprinted, formed by a set of interpenetrating unitary elements.

### TECHNICAL FIELD

The present invention concerns the imprinting of a texture on a coating, also known as texturing a coating, notably a coating applied to a wall, a floor or a ceiling or to part of a prefabricated element used in the construction of a wall, a floor or a ceiling.

The present invention more particularly concerns a mat suitable for this kind of imprinting.

### BACKGROUND OF THE INVENTION

It is known to deposit a coating layer on a wall or a floor to be coated. Applied to a façade of a building, the coating generally has a function of decoration and of impermeability. Applied to an inside wall, its function is mainly decorative. There exist different types of coating as a function of the binder that it contains. A coating can contain an organic binder, for example an acrylic resin (organic coating) or a mineral binder for example cement, plaster and/or lime (mineral coating). The choice of the type of coating depends on the intended application.

To enhance the esthetic appearance of the coating, it is known to apply to the as yet not hardened coating a mat having a surface in texture generally comprising decorative patterns.

For example, patent application FR 2 777 829 describes a method in which a mat with decorative patterns is applied to a fresh coating layer for between a few minutes and a few hours, before being removed. The mat can take the form of a thin rigid or semi-rigid plastic film having a high weight per square meter, applied to the coating with the aid of a brush or a trowel. In this case the decorative patterns are produced on the film by thermoforming or embossing. The mat can also comprise a roller with a texture applied to the coating layer with a PE type plastic film between them, in order to prevent the coating sticking to the roller. The decorative patterns can be imitations of planks of wood, weaving, bricks, tiles, stones, paving, leaves, earth, etc.

The method described in the above document is difficult to use, however, since it necessitates correct positioning of the mat by means of positioning markers at the time of treating two adjacent zones of the substrate, in order to prevent the joins between said zones being visible.

### OBJECT AND SUMMARY OF THE INVENTION

One objective of the present invention is to propose a mat able to remedy the aforementioned disadvantages.

This objective is achieved with a mat intended for imprinting a texture on a coating, notably a coating applied to a wall, a floor or a ceiling or to prefabricated elements used in the construction of a wall, a floor or a ceiling, said mat having a surface with a so-called random texture to be printed, formed by a set of interpenetrating unitary elements.

In the present description, by random texture is meant a texture in which the unitary elements are distributed over the surface in a random manner.

The texture of the mat is typically considered relative to a base surface of the mat, visible or not, which can be plane or have a radius of curvature over all or part of its extent.

A unitary element forming the texture can be a local increase in height of the surface of the mat relative to the aforementioned base surface (for example a boss or a spike), in which case the texture is referred to as “positive”, or a local reduction in height relative to said base surface, in which case the texture is said to be “negative”.

It has nevertheless been observed that a “positive” texture makes it possible to obtain a more legible imprint of the texture on the coating. This also contributes to preventing air pockets between the mat and the coating. The esthetic appearance obtained in this way is particularly neat. The texture can also be a combination of local increases in height and local reductions of height relative to the base surface.

According to the invention, the unitary elements interpenetrate i.e. the unitary elements are not strictly contiguous by virtue of the edges of their base perimeter coming into contact, but each unitary element is truncated by the intersection of its volume with the volume of at least one other adjacent unitary element. The disposition being random, the volumes of adjacent elements interpenetrate by a randomly varying amount.

Each unitary element of the texture extends over its own zone (which is not interpenetrated, i.e. not truncated), in which the texture corresponds to its own texture, and over at least one interpenetration zone in which it interpenetrates with at least one adjacent unitary element.

The mat according to the invention is particularly—but not in a limiting way—suitable for imprinting a coating on a façade of a building (new build or refurbishment), an external thermal insulating composite system (ETICS) for a building, or an inside wall of a building.

Thanks to the random character of the texture and to the interpenetration of the unitary elements constituting it, the texture can be superimposed on itself without visible joins and without destroying its legibility. In other words, the texture can be imprinted on a first treatment zone T1 of a coated surface, and then on a second treatment zone T2 overlapping in part the zone T1, without any join being visible at the edges of the zone of superimposition of T1 and T2, i.e. without the superimposition zone being visually distinguishable from the non-superimposition zones.

The use of markers for positioning the mat is therefore not necessary.

According to one example, the surface of the mat having the texture to be imprinted has a total surface area between 0.1 and 1.5 m² inclusive.

The texture to be imprinted can include an extremely variable number of unitary elements per unit surface area. For example, but not in a limiting way, the number of unitary elements per m² of surface area can be between 10 and 10 000 inclusive.

According to one disposition, there can be at least 10 unitary elements on the total surface area of the mat including the texture to be imprinted, so as to guarantee a certain density of the patterns. Once again, however, this example is not of a limiting nature.

Two types of textures are distinguished in the present description: textures with invisible interpenetration on the one hand and textures with visible interpenetration on the other hand.

A texture with invisible interpenetration is such that it is impossible to see the contour of a unitary element in its interpenetration zone. In this case, the visible part of the unitary element is limited to its own zone.

According to one example of a texture with invisible interpenetration, the unitary elements are of polyhedral shape, with edges which can be straight or curved, and the faces can be plane or curved, notably of pyramidal shape, preferably with as base a polygon with at least 3 sides, in particular at least 5 sides.

A texture with visible interpenetration is such that it is possible to see the contour of a unitary element in its interpenetration zone. In this case, at least part of the unitary element remains visible beyond its own zone, and all of the unitary element can be discerned by observation.

According to one example of a visible interpenetration texture, each unitary element is formed of a set of concentric ribs separated by valleys.

For the remainder of the present description, the profile of the texture of the mat is defined as the profile of that texture as seen in section in a transverse plane substantially orthogonal to the base surface of the mat.

The profile of the texture is generally constituted of a succession of profiled elements each constituted by the succession of one projection and one recess of the profile.

The visible height of a profile element is defined as the height measured between the highest point of the profile element (top of the projection) and its lowest point (bottom of the recess).

The average visible height of the unitary elements of the texture is defined here as the arithmetic mean of the absolute values of the visible heights of the profile elements over a base length of 10 centimeters.

According to one example, the average visible height of the unitary elements of the texture to be imprinted is between 0.5 and 50 mm inclusive, preferably between 1 and 20 mm inclusive.

This average visible height is to be distinguished from the absolute height of each unitary element of the texture, which is the height of that element measured relative to the base surface of the mat. This absolute height is generally the same for all the unitary elements constituting the texture. Note that in the case of visible interpenetration textures, the absolute height can be equal to the visible height.

According to a preferred embodiment, the unitary elements interpenetrate two by two without truncating the top of each unitary element in the case of positive textures, respectively without truncating their bottom in the case of negative textures. In other words, the top, respectively the bottom, of each unitary element remains within its own zone.

The visible width of a unitary element of the texture is defined as the diameter of the smallest circle in which the own zone of that unitary element is inscribed in the case of an invisible interpenetration texture, and as the diameter of the smallest circle in which the entire unitary element is inscribed in the case of a visible interpenetration texture.

According to one example, the maximum visible width of the unitary elements of the texture to be imprinted is between 1 and 100 mm inclusive, preferably between 1 and 50 mm.

The unitary elements forming the texture do not necessarily all have the same shape, the same dimensions or the same orientation. However, as explained above, the absolute height of all unitary elements and thus of all types of unitary element is generally identical.

According to one particular example, the texture comprises at least one first group of unitary elements and at least one second group of unitary elements of identical shape to those of the first group but having a different orientation to that of the first group, notably by virtue of rotation about an axis orthogonal to the base surface of the mat, the elements of each group being distributed in a random manner over the surface of the mat.

According to one particular preferred example, all the unitary elements of the texture are of identical shape.

The unitary elements can be of identical shape and have identical or different dimensions. For example, the unitary elements can take the form of hexagonal pyramids, of identical absolute height, but with bases of different widths. It is highly preferable for the unitary elements to be of identical shape and size, which enables very good superimposition with no visible joins.

The invention also concerns a tool comprising a mat as defined above for imprinting a texture on a coating, notably a coating applied to or forming the surface of a wall, a floor or a ceiling or a coating forming all or part of a prefabricated element used in the construction of a wall, a floor or a ceiling.

According to one example, the tool can be a manual tool intended to be used directly on site by one or more operatives. This tool can for example be a roller or a tamping tool.

According to another example, the tool can be a robotized tool, intended to be used on site.

A mat according to the invention can equally be employed in the production of pre-matted prefabricated elements, for example in the form of pre-matted panels, notably exterior cladding panels, able in particular to be juxtaposed side by side without paying particular attention to their placement, the esthetic continuity of the overall texture formed by the panels being ensured by the random character of the texture and the interpenetration of the unitary elements forming it.

The mat can therefore be integrated for example into an industrial texturing process on a production line manufacturing a coated element or a prefabricated board from a malleable material, notably cement, plaster, clay, earth, or an organic-based coating, and intended for use on a façade, a floor or internally. The mat is for example integrated into rollers enabling continuous texturing of prefabricated elements of the aforementioned type on a production line.

According to another example, the mat is a digital mat that can be used in a continuous 3D printing system.

The digital mat comprises the digital file of the coordinates of the points defining the surface (topography) of the texture to be imprinted, together with instructions adapted to move the head of the printer into a sequence of positions according to said coordinates. The invention then also consists in a computer program comprising computer code for executing the steps of the 3D printing process using the digital mat when the program is executed in a computer or an additive fabrication machine. It also consists in a machine-readable medium containing the digital file of the digital mat, including the computer code of a computer program for executing the 3D printing process using the digital mat, when the program is executed in a computer or an additive fabrication machine.

The mat can equally be integrated into a molding process, being placed in the mold bottom. It can for example be used for the production of construction or cladding parts and in particular pre-matted concrete, molded using shuttering or in accordance with any existing industrial molding technique.

The invention finally concerns a substrate chosen from a wall, a floor or a ceiling or a prefabricated element intended to form a wall, a floor or a ceiling, said substrate being coated with a coating or said element having a surface layer having an imprinted texture that can produced using a mat as defined above, in which the imprinted texture corresponds to the imprint left by a so-called random texture to be imprinted, formed by a set of interpenetrating unitary elements.

A number of examples or embodiments are described in the present description. However, unless otherwise specified, the features described, in connection with any one example or embodiment, can be applied to any other example or embodiment.

The invention further concerns a method of imprinting a texture on a coating, notably a coating applied to a given area of a wall, a floor or a ceiling or applied to a prefabricated element used in the construction of a wall, a floor or a ceiling, said imprinting being done with a tool comprising the mat according to the invention, characterized in that said method includes a step consisting in applying the tool to a plurality of treatment zones to imprint said texture, the tool being applied in a random manner, until all the surface of said zone to be imprinted is covered with the pattern.

According to one example, the application step is carried out so that at least some the treatment zones overlap. By random application is meant that the various applications are not interdependent, i.e. their position, their orientation does not depend on the position and the orientation of the mat during the immediately preceding application.

### BRIEF DESCRIPTION OF THE DRAWINGS

The invention will be clearly understood and its advantages will become more apparent on reading the following detailed description of a number of embodiments shown by way of nonlimiting example. The description refers to the appended drawings, in which:

FIG. 1 shows a mat according to a first embodiment of the invention;

FIG. 2 shows a unitary element of the texture from FIG. 1, seen from above;

FIG. 3 shows in more detail the texture of the mat from FIG. 1;

FIG. 4 is a view in section taken along the transverse line IV-IV in FIG. 3;

FIG. 5 shows unitary elements forming the texture from FIG. 1, with identical shapes and dimensions but different orientations;

FIG. 6 shows different treatment zones of a coating treated using a mat according to the invention;

FIG. 7 shows part of a substrate coated with a coating layer having an imprinted texture produced using a mat according to FIG. 1;

FIG. 8 shows a texture surface of a mat according to a second embodiment of the invention;

FIG. 9 shows a texture surface of a mat according to a third embodiment of the invention;

FIG. 10 shows a texture surface of a mat according to a fourth embodiment of the invention;

FIG. 11 shows a texture surface of a mat according to a fifth embodiment of the invention.

### DETAILED DESCRIPTION OF EMBODIMENTS

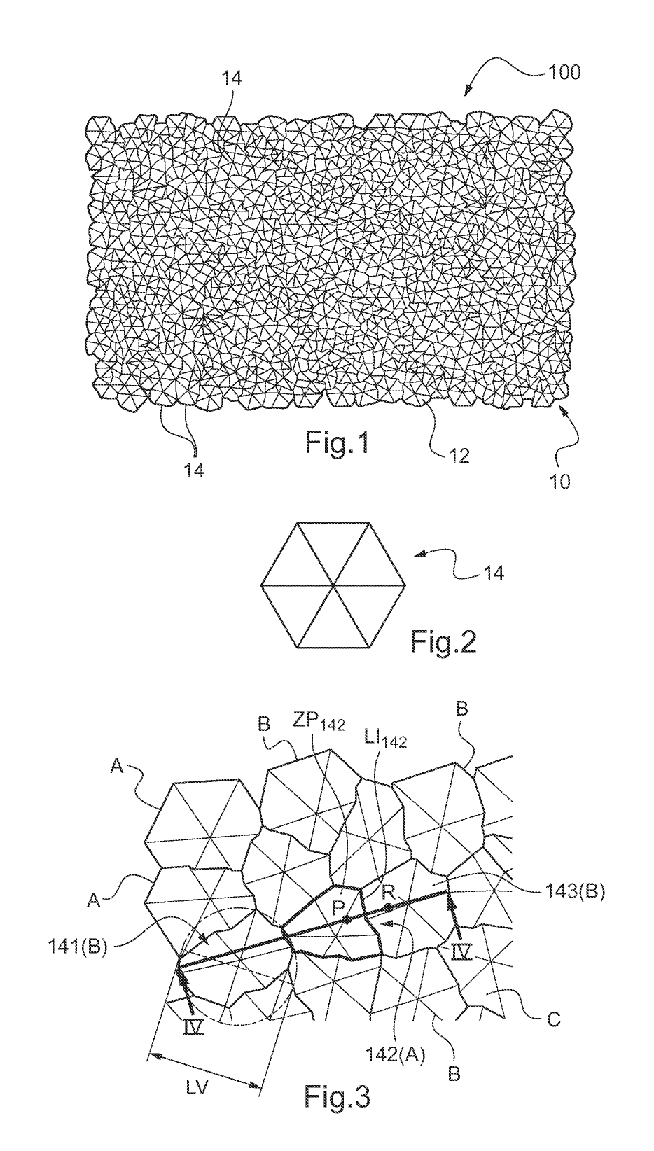

FIG. 1 shows a mat 100 according to a first embodiment, intended for imprinting a texture on a coating, notably a façade of a building.

The mat 100 includes a surface 10 with a so-called random texture 12 to be imprinted, formed by a set of interpenetrating unitary elements 14.

The textured surface typically has a total surface area between 0.1 and 1.5 m² inclusive.

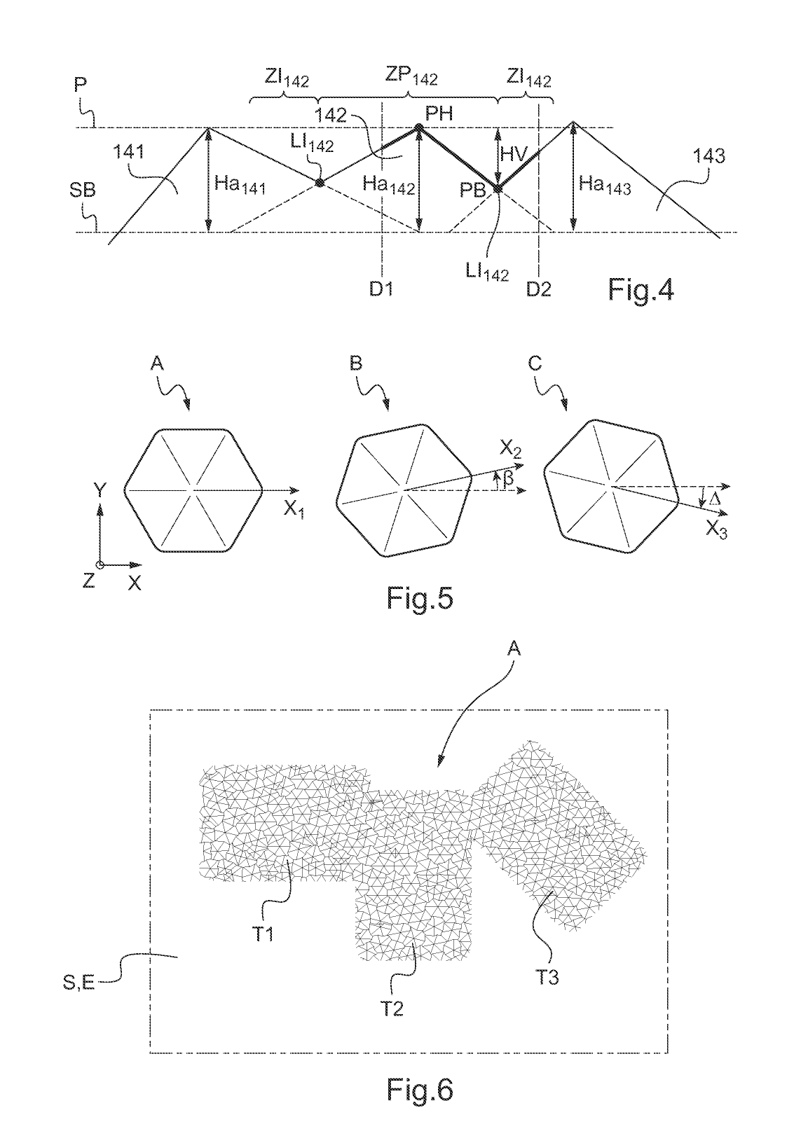

In the example, the texture is a so-called “positive” texture, formed by the random juxtaposition of unitary elements 14 over a so-called base surface SB of the mat (shown by way of illustration in FIG. 4).

In this instance, the unitary elements 14 of the texture 12 from FIG. 1 are pyramids of the type shown from above in FIG. 2, with bases in the shape of a regular hexagon.

FIG. 2 shows a pyramid of this kind from above, and FIG. 3 shows in more detail the texture of the mat and the interpenetration of the unitary elements.

For a clearer understanding, the profile of the texture of the mat in section taken along the line IV-IV in FIG. 3, orthogonal to the base surface SB of the mat, is shown in FIG. 4. In that figure, the elements in dashed line are elements that do not exist in the final volume. These are imaginary lines that serve only to illustrate how the general structure of the texture is constituted.

The three hexagonal pyramids 141, 142 and 143 seen in FIG. 4 will be described in more detail by way of example.

In the example, the base surface SB is a plane surface, defined when modeling the mat. The texture is formed by juxtaposing the pyramids in a random manner over this base surface, the bases of the pyramids therefore coinciding with the base surface of the mat.

As shown in FIG. 4, the absolute heights of the pyramids 141, 142, 143, in other words the height of their top relative to the base surface B, are respectively denoted Ha₁₄₁, Ha₁₄₂ and Ha₁₄₃ and are identical with Ha₁₄₁=Ha₁₄₂=Ha₁₄₃=Ha. The tops of the pyramids forming the texture to be imprinted are therefore defined in the same plane P, shown in dashed line in FIG. 4.

According to the invention, each pyramid forming the texture to be imprinted interpenetrates with at least one adjacent pyramid. The pyramids therefore merge locally and each pyramid extends over an own zone ZP, on which the texture corresponds to its own texture, and over an interpenetration zone ZI, in which the pyramid merges with one or more adjacent pyramids and where the texture corresponds to the texture of one or the other pyramid.

There can in particular be defined, for each pyramid 14, a continuous interpenetration line LI closed on itself delimiting the own zone ZP. By way of example, the own zone ZP₁₄₂ of the pyramid 142 is referenced in FIG. 3 and the interpenetration line LI₁₄₂ of said pyramid is shown in bold in that same figure. The own zones and interpenetration zones ZP₁₄₂ and ZI₁₄₂, respectively, of the pyramid 142 and the interpenetration lines LI₁₄₂ are moreover identified in FIG. 4.

Here the pyramids 14 interpenetrate invisibly. In other words, the part of each pyramid 14 extending beyond its own zone ZP can no longer be distinguished, because it merges with the own zones of the adjacent pyramids.

The absolute height Ha, defined above, is therefore difficult to measure on the finished product.

It is nevertheless possible to measure the average visible height of the texture, in the following manner based on the profile of the mat (as seen in section taken along the line IV-IV).

An element of the profile is defined as the succession of one projection of the profile and an adjacent recess of the profile. In FIG. 4, an element of the profile is defined between the two lines D1 and D2 and shown in bold.

The visible height HV of this element of the profile is defined as the height measured between the highest point PH of that element (top of the projection) and its lowest point PB (bottom of the recess).

Finally, the average visible height of the pyramids of the texture is defined as the arithmetic mean of the absolute values of the visible heights HV of the various elements of the profile over a base length of 10 centimeters. This average visible height is for example between 0.5 and 50 mm inclusive, preferably between 1 and 10 mm inclusive.

The visible width of a pyramid 14 corresponds to the diameter of the smallest circle in which the own zone ZP of said pyramid 14 is inscribed. In FIG. 3, there has been represented by way of example the visible width LV of the pyramid 141.

The maximum visible width of the pyramids 14 of the texture is typically between 1 and 100 mm inclusive.

The texture to be imprinted advantageously includes between 10 and 10 000 unitary elements per m² of surface area.

Note that in the particular example shown, the pyramids 14 do not all have the same orientation.

In particular, as shown in FIG. 3, here the texture comprises a first group of pyramids A (to which belongs in particular the pyramid 142), a second group of pyramids B (to which belong in particular the pyramids 141 and 143) and a third group of pyramids C of the same shape and size but with different orientations, the elements of each group being distributed in a random manner over the surface of the mat.

In FIG. 5 there is shown a pyramid of the first group A (referenced A), a pyramid of the second group B (referenced B) and a pyramid of the second group C (referenced C), in a system of axes X, Y, Z. The bases of the pyramids A, B, C are defined in the plane X, Y. The axes of the pyramids are parallel to the axis Z.

As is clear from FIG. 5, the base of the pyramid B is here pivoted relative to that of the pyramid A by an angle β strictly between 0 and 30° inclusive about an axis parallel to Z, in the counterclockwise direction. In the same plane, the base of the pyramid C is pivoted relative to that of the pyramid A by an angle Δ strictly between 0 and 30° inclusive around an axis parallel to Z, in the clockwise direction. Obviously, this example is not of a limiting nature, and the orientation differences between the various groups of unitary elements could vary greatly (with different angles in the same direction of pivoting, for example).

The texture 12 as defined above is capable of being superimposed on itself without visible joins and without destroying its legibility. During the matting operation of which a step is shown in FIG. 6, the substrate surface S covered with green (i.e. not yet hardened) coating E is treated over different zones Ti (hereinafter treatment zones) partially intersecting (i.e. partially superimposed). Here by treated is meant imprinted by application of the mat 100. Despite the overlapping of the treatment zones, the imprinted texture is very homogeneous. The superimposition zones cannot be distinguished visually from the non-superimposition zones. The drawing represented in this figure constitutes the total texture composed by the successive applications of the mat, as seen via the coating E the position of which is situated in front of the plane of the paper.

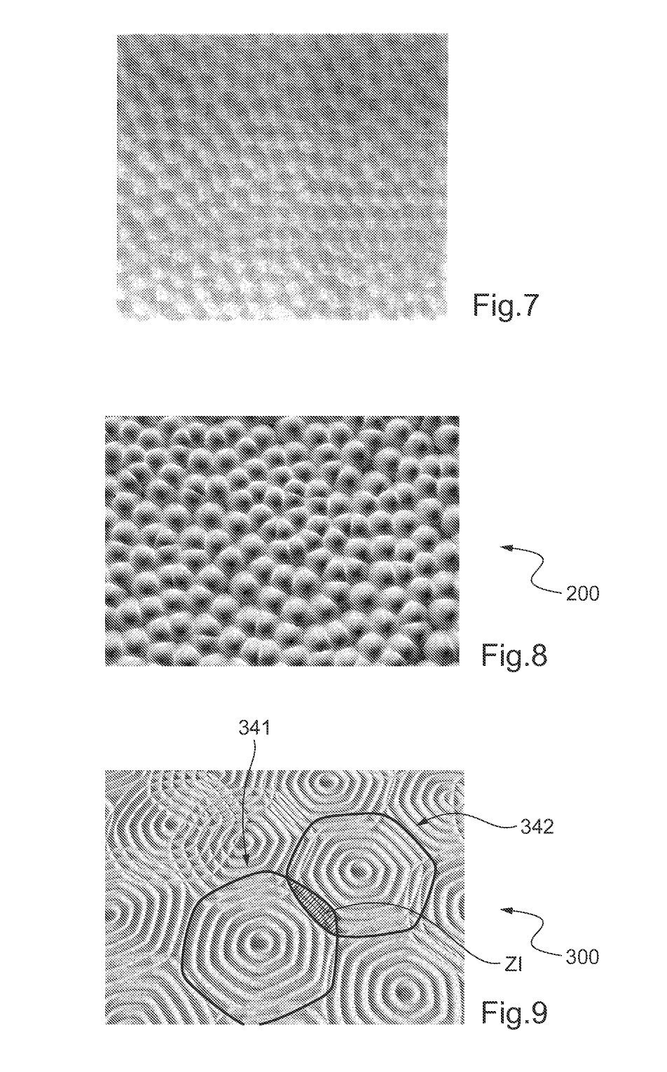

A substrate S with a texture R imprinted using said mat described above is shown in FIG. 7. The texture R imprinted on the substrate S corresponds to a negative image of the texture 12 of the mat to be imprinted.

The example described with reference to FIGS. 1 to 7 is not of a limiting kind, however, and in accordance with variant embodiments the texture can in particular be formed of unitary elements with the same orientation but varying dimensions, or unitary elements of the same shape, with the same dimensions and even the same orientation, or elements with different shapes, dimensions and orientations, etc.

FIG. 8 shows a mat 200 in accordance with a second embodiment, comprising a texture surface formed by a set of rounded protuberances with the same shape and the same dimensions, interpenetrating in a random manner and invisibly.

FIGS. 9 to 11 show texture surfaces of matrices according to other embodiments of the invention.

In contrast to the first two embodiments described above, the textures shown here are textures with visible interpenetration. In the interpenetration zones, it is possible to distinguish the parts of one and the other of the interpenetrating unitary elements.

In the FIG. 9 embodiment, for example, the mat 300 has a texture formed by a set of interpenetrating unitary elements, each unitary element being constituted of a plurality of (here six) concentric ribs. Here the unitary element is formed by a circular central rib and five hexagonal ribs with curved sides.

There have been shown in bold in the figure the peripheral edges of two interpenetrating unitary elements 341, 342. The cross-hatched area corresponds to the interpenetration zone ZI of the unitary element 341 with the unitary element 342. In this area, it is however possible to distinguish the ribs of the adjacent element 342.

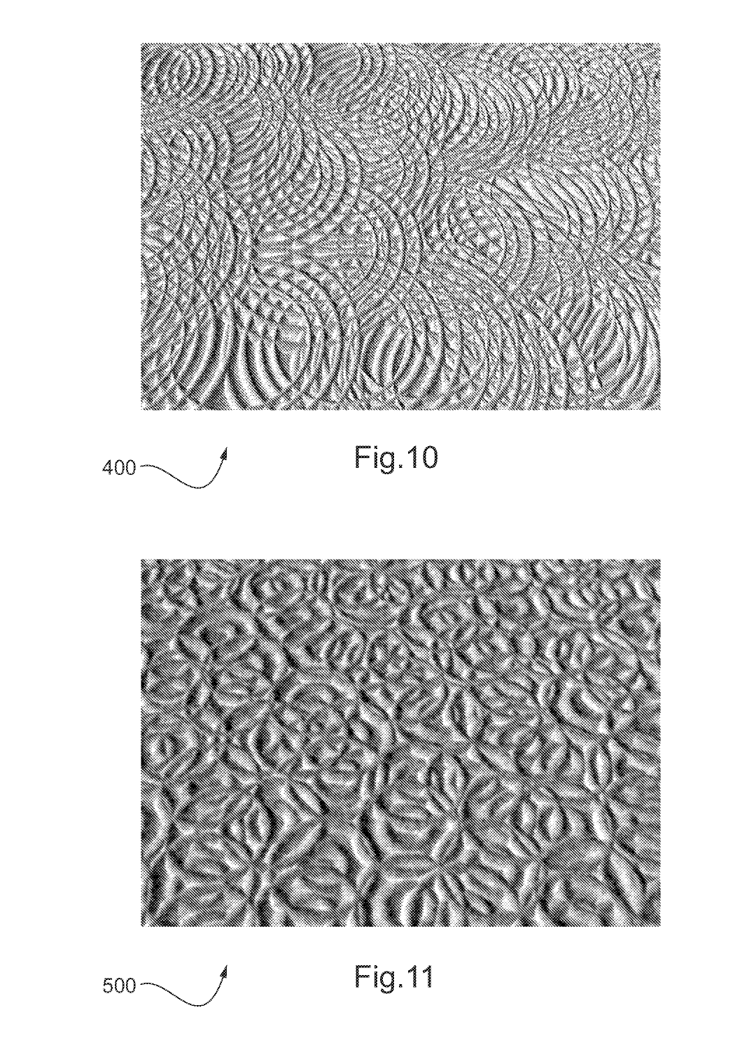

In the FIG. 10 embodiment, the mat 400 has a texture formed by a set of interpenetrating unitary elements, each unitary element being constituted of a plurality of (here four) concentric circular ribs.

In the FIG. 11 embodiment, the mat 500 has a texture formed by a set of interpenetrating unitary elements, each unitary element being constituted of a plurality of (here two) concentric circular ribs.

1. A mat intended for imprinting a texture on a coating, the coating to be applied to a wall, a floor or a ceiling or to a prefabricated element used in the construction of a wall, a floor or a ceiling, said mat having a surface provided with a random texture to be imprinted, formed by a set of interpenetrating unitary elements.

2. The mat as claimed in claim 1, wherein the random texture comprises at least one first group of unitary elements and at least one second group of unitary elements of identical shape to those of the first group but having a different orientation to that of those of the first group, the unitary elements of each of the at least one first group and of the at least one second group being distributed in a random manner over the surface of the mat.

3. The mat as claimed in claim 1, wherein all the unitary elements of the random texture are of identical shape.

4. The mat as claimed in claim 3, wherein all the unitary elements of the random texture are of identical shape with varying dimensions.

5. The mat as claimed in claim 3, wherein all the unitary elements of the random texture are of identical shape with identical dimensions.

6. The mat as claimed in claim 1, wherein the random texture to be imprinted is an invisible interpenetration texture.

7. The mat as claimed in claim 1, wherein the unitary elements are of polyhedral shape, the edges of which can be straight or curved, and the faces of which can be plane or curved.

8. The mat as claimed claim 1, wherein the random texture to be imprinted is a visible interpenetration texture.

9. The mat as claimed claim 1, wherein an average visible height of the unitary elements of the random texture to be imprinted is between 0.5 and 50 mm inclusive.

10. The mat as claimed in claim 1, wherein a maximum visible width of the unitary elements of the random texture to be imprinted is between 1 and 100 mm inclusive.

11. The mat as claimed in claim 1, wherein the surface with the random texture has a total surface area between 0.1 and 1.5 m² inclusive.

12. The mat as claimed in claim 1, wherein the random texture to be imprinted includes between 10 and 10 000 unitary elements per m² of surface area.

13. A tool for imprinting a texture on a coating, the coating to be applied to a wall, a floor or a ceiling or to a prefabricated element used in the construction of a wall, a floor or a ceiling, comprising a mat as claimed in claim 1.

14. A substrate chosen from a wall, a floor or a ceiling or a prefabricated element intended to form a wall, a floor or a ceiling, said substrate being coated with a coating or said element having a surface layer featuring an imprinted texture that can be produced by a mat as claimed in claim 1, wherein the imprinted texture corresponds to the imprint left by a random texture to be imprinted, formed by a set of interpenetrating unitary elements.

15. A method of imprinting a texture on a coating, the coating to be applied to a given area of a wall, a floor or a ceiling or to a prefabricated element used in the construction of a wall, a floor or a ceiling, said imprinting being done with a tool comprising the mat as claimed in claim 1, method comprising a step consisting in applying the tool to a plurality of treatment zones to imprint said texture, the tool being applied in a random manner, until the entire surface of said zone to be imprinted is covered with the pattern.

16. The imprinting method as claimed in claim 15, wherein the application step is carried out for at least some of the overlapping treatment zones.

17. The mat as claimed in claim 7, wherein the unitary elements are pyramidal.

18. The mat as claimed in claim 7, wherein the unitary elements have as a base a polygon with at least 3 sides.

19. The mat as claimed claim 9, wherein an average visible height of the unitary elements of the texture to be imprinted is between 1 and 20 mm inclusive.
